(19) United States
(12) Patent Application Publication
(10) Pub. No.: US 2006/0151543 A1
(43) Pub. Date: Jul. 13, 2006

(54) Dispensable adhesive and sealants with color differentiated components

(75) Inventors: William J. Longo II, Mentor, OH (US); Thomas J. Rapps, Olmsted Falls, OH (US)

Correspondence Address: Thomas E. Young, Esq.;Fay, Sharpe, Fagan, Minnich & McKee, LLP, Seventh Floor, 1100 Superior Avenue, Cleveland, OH, 44114-2579, US

(73) Assignee: Henkel Consumer Adhesives, Inc.

(21) Appl. No.: 11/325,179

(22) Filed: Jan. 4, 2006

Related U.S. Application Data
(60) Provisional application No. 60/642,864, filed on Jan. 11, 2005.

(51) Int. Cl. B65D 88/54; G01F 11/06; G01F 11/30

(52) U.S. Cl. 222/327

(57) ABSTRACT

A caulk, sealant or adhesive product is provided in a tubular package with at least one body of chromatic indicator material provided as a body disposed longitudinally within the tube. The caulk, sealant or adhesive can be applied with a caulking gun to produce a bead having a colored stripe for decorative or property indicating purposes. The stripe may be kept visible in the applied bead or applied so as to be concealed. The stripe is useful for quality control purposes.

### PRIORITY CLAIM

This application claims priority of U.S. Provisional Patent Application No. 60/642,864 entitled Dispensable Adhesive and Sealants with Color Differentiated Components filed Jan. 11, 2005.

### FIELD OF THE INVENTION

The present invention is in the general field of dispensable, viscous chemical materials and compositions such as adhesives, caulks and sealants, and more particularly pertaining to building materials which are dispensed or extruded under pressure from a cartridge or tube.

### BACKGROUND

Building materials in the form of viscous compositions, such as adhesives, caulks and sealants, are frequently packaged in cartridges or tubes. These cartridges or tubes are often of standard sizes and conformations. The tubes are often cylindrical having a nozzle at the center of a dispensing end and a disk with a cylindrical sidewall closing the piston end. A seal is often included at the base of the nozzle. Such cartridges or tubes of adhesives, sealants and caulks are available from many sources. The tubes are substantially constructed of plastic or thick cardboard to withstand the pressure required for dispensing and to otherwise resist breakage.

Dispensers for the products in these cartridges or tubes are often referred to as caulking guns. A caulking gun has a frame which accepts a cartridge or tube, restrains the front of the tube while allowing access to the nozzle and provides a push rod which engages the disk at the piston end. The push rod is ratcheted and operated by a hand actuated lever on the caulking gun handle. Other types of dispensers, include power operated dispensers performing the same functions described above. Some power operated dispensers have a cavity receiving adhesive, sealant or caulk in a cylindrical container without a nozzle. These containers are sometimes called “sausages” because of their visual resemblance to the food product. In operation, these dispensers provide pressure at the piston end of the cartridge or tube so the products within are dispensed through a nozzle attached to the cartridge or dispenser.

Caulks, sealants and single component adhesives dispensed from tubes are generally homogenous in color, and the dispense pattern is dictated by the pressure applied, and the shape and size of the nozzle opening and the rate at which the nozzle is moved. As the material exits the tube nozzle, it forms a bead which is also generally homogenous in shape and color. The dispensed material flows and settles depending upon viscosity, temperature and orientation.

Adhesive sealants and caulk are used in many roles in the construction and maintenance of homes and other buildings and in manufacturing. Adhesives are used to bond sub flooring and flooring. Adhesives are used to bond wall panels to structural members. Adhesives are used with tile, vinyl sheeting and in many other building applications.

Sealants are used to close gaps in many building applications. When windows are installed, the periphery of the windows abut siding and frame elements. Sealants are used to close gaps around the window and prevent moisture intrusion. The installation of vinyl or aluminum siding on a building often involves use of a sealant at corners, around fixtures, windows and doors. The sealant is often selected to have the same color as the siding. Adhesives, are also sometimes selected to have the same color as surrounding materials as adhesive may be visible in the finished job.

Sealants and adhesives are formulated to perform differing tasks in different environments and with different materials. Sealants and adhesives are formulated from different polymer combinations to meet various needs. Sealants and adhesives are formulated based on silicones, polyurethanes, polysulfides, latex and other polymers and combinations of polymers. While all these products are sealants or adhesives, a specific sealant may have qualities making it appropriate for use in sealing around the periphery of a bath tub, while a second sealant might be appropriate for sealing between a wooden window frame and aluminum siding. The first is formulated to adhere to and seal tile (ceramic) to a porcelain bath tub. It must be mildew resistant. It must be removable should the homeowner redecorate. The second must adhere to both wood and painted aluminum. It must be sunlight and weather resistant and have a long life as it is used in places which are difficult to reach. One could be used in place of the other; but may not do a good long term job. There are many types of sealants to address many different applications. Contractors may have more than one type of sealant on a work site to address different applications. These sealants may have the same or very similar colors to match surrounding substrates. However, workers need to differentiate one from the other.

Sealants are often sold in tubes with a dispensing nozzle. A seal is positioned at the base of the nozzle. The tube is inserted into a caulking gun, the tip cut off the nozzle and the seal broken. Sealant is dispensed as desired by operating the caulking gun. Sealant is dispensed into gaps or the like in a long, narrow body commonly called a bead. When the sealant tube is in the caulking gun, a portion of the tube outer surface is hidden from view. Moreover, construction sites are often messy. Sealant tubes may be discolored by misplaced paint or sealant obscuring markings. In this environment, one sealant may be mistaken for another. Even a well marked tube may be positioned in a caulking gun with type markings obscured or painted over.

### SUMMARY OF THE INVENTION

It is an object of the invention to provide an indicator for sealants, caulks and adhesives contained in dispensing tubes and similar containers which will be visible to the user regardless of the orientation or state of the exterior of the tube.

It is a further object of the present invention to provide an indicator for sealants, caulks and adhesives which will be visible in a sample of the sealant, caulk or adhesive as dispensed from its container but may be selectively concealed or displayed in a bead laid down by the applicator.

It is yet another object of the present invention to provide an indicator for sealants, caulks and adhesives which will be visible in the sealant, caulk or adhesive as dispensed from its container but which will disappear after exposure to ultraviolet radiation, as is present in sunlight, for a selected period of time.

The present invention provides a novel flowable and dispensable building material which combines a principal material and a chromatic indicator material which is co-dispensed with the principal material from a cartridge or other container. In one embodiment, a principal material such as a viscous adhesive, sealant or caulk, is contained or packaged in a tube or cartridge or other container in which a chromatic indicator material is also contained and is co-dispensed with the principal material in an arrangement wherein the two materials and their respective colors remain segregated and visually distinct. The invention further provides a novel flowable and dispensable building material which includes the novel combination of a principal material-such as adhesive, sealant or caulk or any other viscous flowable material and a chromatic indicator material in a linear pattern in combination with the principal material.

In one embodiment, the dispensed building material is in the form of a bead which is made of the principal material and the chromatic indicator material in a pattern which is visually distinct from the principal material. The chromatic indicator material may be a smaller, greater or equal component of the bead than the principal material and which is in a linear form and visible along with the principal material. There may be two or more chromatic indicator materials. A tube or cartridge may be filed with a principal material with two segments of chromatic indicator material occupying adjacent narrow segments thereby providing a dispensed bead having a principal material with adjacent narrow stripes of different colors.

In a particular embodiment of the invention, the principal material and the chromatic indicator material are dispensed from a cartridge in equal parts with a visually distinct chromatic dividing line between the two materials.

In another embodiment of the invention, one of the two combined and co-dispensed or co-extruded materials has a color and composition which is different than a color and composition of the other material. For example, in a urethane-containing extrudable adhesive, one of the materials-the principal material or the chromatic indicator material may contain a different amount of urethane than the other material.

The chromatic indicator material may be reactive to sunlight whereby its visual distinctiveness fades away over a selected period of time after application. The chromatic indicator material may be reactive to air or moisture whereby its visual distinctiveness fades away over a selected period of time after application. The chromatic indicator material may be sensitive to light of a selected wavelength whereby its visual distinctiveness is apparent only when illuminated by light of the selected wavelength.

The combined material of the invention is applicable to all types of compositions which are cartridge dispensed, including cartridge and sausage grade adhesives, and including but not limited to solvent, latex, polyurethane, silicone, polysulfide and neoprene technologies.

Several words are used to describe related products in the construction industry and in industry in general. A “caulk” is a product used to seal gaps or crevices. “Caulk” is usually used to mean a product making a water tight seal. The term is used to describe products for sealing seams in boats and marine environments and also more generally. “Sealant” is often used to refer to two different classes of products. One is a paste-like product used to fill gaps and voids and seal fluids in or out. The second is a flowable liquid product used to coat a porous surface and make the surface fluid tight. An “adhesive” is a substance used to bind two workpieces together. Adhesives are often formulated to adhere to selected substrates in selected conditions with a selected strength. Caulks and sealants have adhesive characteristics, but are formulated to optimize sealing over strength of adhesion. The present invention is concerned with caulks, sealants and adhesives in paste form. These products are often sold in tubes and are viscous or paste like when applied to a substrate and will form a bead on the substrate. The words “caulk” and “sealant” will be used interchangeably herein to mean a viscous or paste-like product adapted to seal gaps, crevices and the like.

Adhesives and adhesive compositions produced according to the invention as a combination of a principle material and a chromatic indicator material are not limited to accredited specification certifiers or governmental specifications generally attributed to cartridge or sausage grade adhesives.

Further objects and advantages of the invention will be apparent from the following detailed description of the preferred embodiments thereof and from the accompanying drawings.

### BRIEF DESCRIPTION OF THE DRAWINGS

The invention may take physical form in certain parts and arrangements of parts, preferred embodiments of which will be described in detail and illustrated in the accompanying drawings which form a part hereof and wherein:

FIG. 1 is a side elevational view, partially in cross section, showing a packaged sealant product in accordance with the present invention;

FIG. 2 is a cross sectional view of the sealant product of FIG. 1 taken along line 2-2 of FIG. 1;

FIG. 3 is a schematic illustration of the packaged sealant product of FIGS. 1 and 2 being applied to form a bead of caulk;

FIG. 4 is a cross sectional view of the bead of caulk seen in FIG. 3;

FIG. 5 is a schematic illustration of an application of the packaged sealant product of FIGS. 1 and 2 with the package sealant product turned 180° prior to application;

FIG. 6 is a cross sectional view of the bead of caulk seen in FIG. 5;

FIG. 7 is an illustration of an alternate embodiment of the invention showing the packaged sealant product in a “sausage” cartridge;

FIG. 8 is a cross sectional view of the packaged sealant product of FIG. 7;

FIG. 9 is a cross sectional view of another alternate embodiment of the invention as would be taken along line 2-2 of FIG. 1 or 8-8 of FIG. 7;

FIG. 10 is a schematic illustration of a bead of caulk in accordance with the embodiment of FIG. 9 after it has been laid down from the tube as seen in FIG. 1;

FIG. 11 is a cross section of the bead of caulk seen in FIG. 10 taken along line 11-11;

FIG. 12 is a cross sectional view of yet another embodiment of the present invention as will be taken along line 2-2 of FIG. 1 or line 8-8 of FIG. 7;

FIG. 13 is a bead of caulk as would be laid down by the packaged sealant product of FIG. 1 filled in accordance with FIG. 12;

FIG. 14 is a cross section of the bead of FIG. 13 taken along line 14-14 of FIG. 13;

FIG. 15 shows a cross sectional view similar to FIG. 2 or FIG. 8 of another embodiment of the invention;

FIG. 16 shows a cross sectional view similar to FIGS. 2 and 8 of still another embodiment of the invention;

FIG. 17 shows a cross sectional view of the bead of caulk similar to the cross sectional view seen in FIG. 4 of still another embodiment of the invention;

FIG. 18 shows a cross sectional view of the bead of caulk seen in FIG. 17 exposed to sunlight;

FIG. 19 shows a cross sectional view of the bead of caulk seen in FIGS. 17 and 18 after prolonged exposure to sunlight;

FIG. 20 shows a cross sectional view of a bead of caulk similar to the cross sectional view seen in FIG. 4;

FIG. 21 shows the cross sectional view of a bead of caulk seen in FIG. 20 as exposed to radiation of a selected wave length;

FIG. 22 shows a cross sectional view of the bead of caulk seen in FIGS. 20 and 21 after the radiation of a selected wave length is removed; and,

FIG. 23 shows a cross section of a body of caulk within a cylindrical side wall according to another alternate embodiment of the invention.

### PREFERRED EMBODIMENTS

Referring now to the drawings wherein the showings are for the purposes of illustrating preferred embodiments of the invention only and not for the purposes of limiting same, FIG. 1 shows, schematically, a packaged sealant, caulk or adhesive product 10 in accordance with the present invention. The outer periphery of the body of the product is defined by a cylindrical side wall 12. The front end of the cylindrical side wall 12 is closed by a annular front wall 14 which surrounds a nozzle 16 extending away from the cylindrical side wall 12. The outboard end of the nozzle 16 is normally closed until the consumer or user cuts off the end to use the sealant contained in the product. A seal (not shown) is generally provided at the base of the nozzle closing the interior of the cylindrical side wall at the front end.

A piston 22 is comprised of a disk 24 surrounded by a cylindrical skirt 26. The piston 22 closes the rear end of the tube formed by the cylindrical side wall 12. These general elements: a cylindrical side wall having a nozzle at one end and a piston at the other; are of a conventional design and standard size and shape. Packaged sealant products of this design can be inserted into a conventional hand operated or power operated caulking gun for dispensing. The dispensing operation usually starts with the operator cutting off the tip of the nozzle 16, puncturing any sealing member at the base of the nozzle, inserting the prepared product into the caulking gun and pushing a ratcheted push bar into engagement with the piston 22. Operation of the gun's trigger advances the push rod which in turn advances the piston urging the product contained within the cylindrical side wall 12 through the nozzle 16 onto a desired substrate.

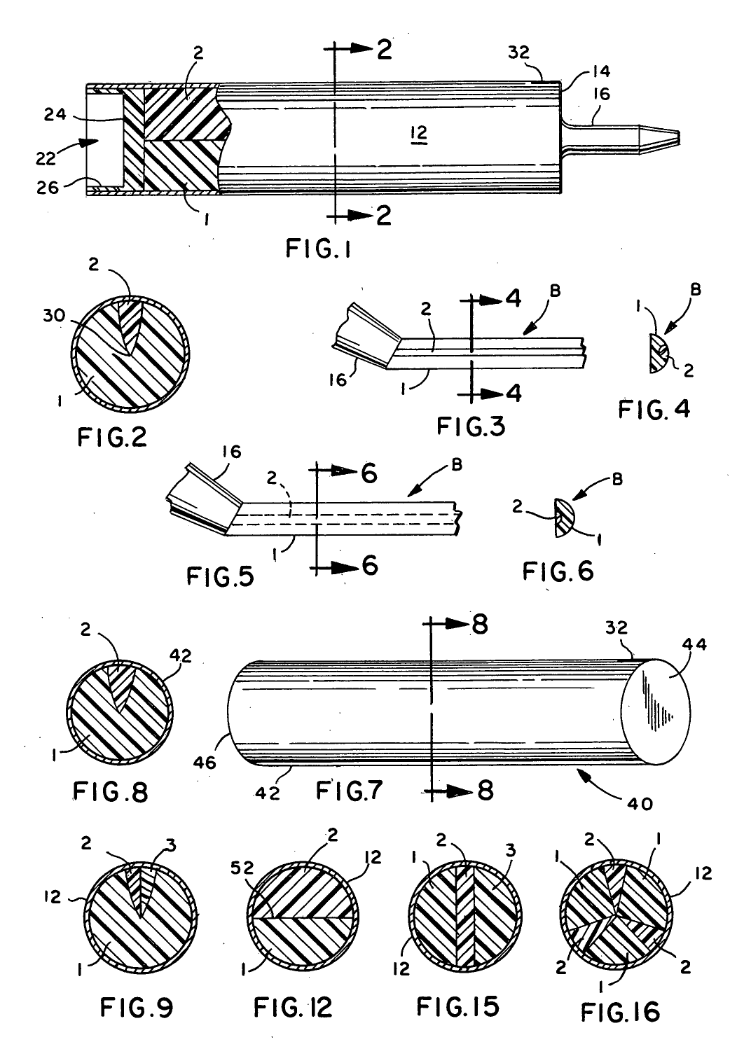

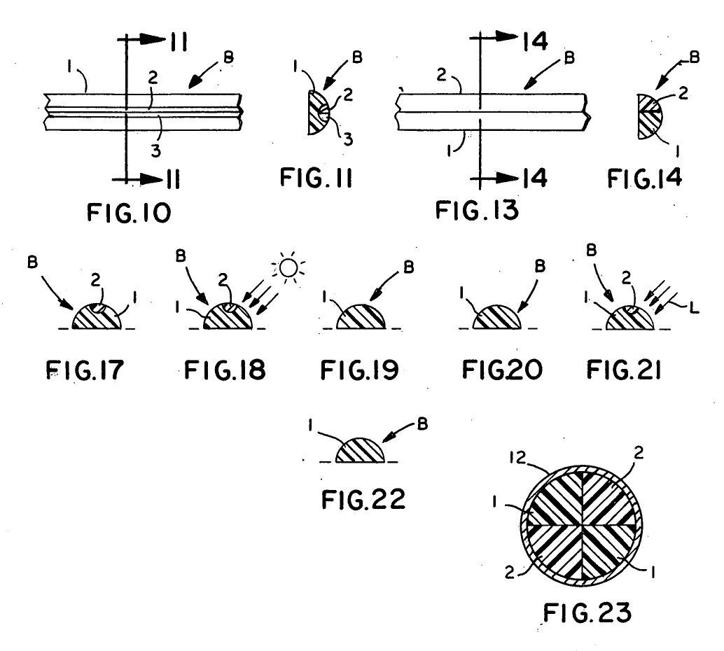

In accordance with the first embodiment of the present invention, a body of paste-like or viscous caulk, sealant or adhesive having two components is contained within the cylindrical side wall 12. A first material or principal material 1 occupies a portion of the volume surrounded by the cylindrical side wall 12. A second material, or chromatic indicator 2, occupies a second portion of the volume surrounded by the cylindrical side wall 12. As can be best seen in FIG. 2, the principal material 1 occupies most of the volume surrounded by the cylindrical side wall 12. The chromatic indicator 2 occupies a much smaller portion of the volume surrounded by the cylindrical side wall 12. The chromatic indicator 2 occupies a wedge shaped volume extending substantially uniformly along the entire length of the body of material contained within the cylindrical side wall 12. As can be best seen in FIG. 2, the wedge shape of chromatic indicator material 2 has its broadest portion at the outer periphery of the body of material and tapers to a point spaced somewhat radially outwardly from the central or axis of the volume contained within the cylindrical side wall 12. As can be seen in FIG. 1, a mark 32 can be optionally placed upon the outside of the cylindrical side wall 12 marking the location of the wedge of chromatic indicator material 2 within.

The principal material 1 can be a caulk, sealant, or adhesive of any type or any formulation. The chromatic indicator or second material 2 can be the same material as the principal material with the addition of a coloring additive so that the chromatic indicator is distinct from the principal material.

Many sealants, caulks, or adhesives of a particular type or formulation are offered in several colors. Thus, caulk to be used in the installation of building siding is often offered in a variety of colors made to match the siding being applied. A manufacturer may offer the same caulk in beige, tan, white, and various other colors matched to the colors used by manufacturers of siding. The same manufacturer may offer different types of adhesive, sealant and caulk in the same or very similar colors. Moreover, these different caulks, sealants and adhesives may be used by contractors and others at the same job site or factory. Thus, one formulation of a sealant may be used in caulking around windows and at joints in siding. A second formulation of adhesive may be used caulking around a brick fireplace and the flue tubes for a water heater or other heat carrying vessel. Still another caulk of the same or similar color may be used around interior joints in a bathroom and kitchen. A manufacturer can select a chromatic indicator color distinctively identifying each class of caulk, thus, one color may indicate general purpose caulk for use on siding while a second color indicates high temperature resistant caulk for use around chimneys and flues and a third color of chromatic indicator identifies for use in bathrooms and kitchens having mildew resistance and other appropriate characteristics. A workman familiar with the system will know by examining the caulk exposed at the opening of the nozzle 16 which type of caulk is in the caulking gun. This is true even if the type markings on the exterior of the packaged sealant product 10 are obscured by the caulking gun or illegible because of dirt, paint or other contaminations.

With reference to FIG. 3, one sees a bead B of caulk as applied to a substrate from the nozzle 16 of the package sealant product 10. This bead B of caulk is shown in cross section in FIG. 4. As can be seen in both FIGS. 3 and 4, bead 2 displays two elements, the principal material 1 and the chromatic indicator 2. Thus, the type of caulking applied is easily determined by simply noting the color the chromatic indicator forming a thin line down the visible periphery of the bead B.

FIGS. 5 and 6 illustrate an alternate application of the same product. In this application, the packaged sealant product has been rotated 180° in the caulking gun so that the indicator mark 32 is no longer visible. The worker can still identify the type of caulk by examining the chromatic indicator at the tip of the nozzle. However, because the chromatic indicator wedge is now oriented downwardly with respect to the substrate, the bead, when applied to the substrate, appears to have only the color of the principal material 1. That portion of the bead containing the chromatic indicator is buried in the center bottom (as seen in the cross section of FIG. 6) and will be invisible in the finished application. Thus, if one is caulking beige aluminum siding with a beige caulk having a red indicator line, the red indicator line is buried and invisible in the finished job. However, the red indicator line is available to the worker during the time of installation. Moreover, should a foreman, quality control inspector or home owner wish to check to assure that the appropriate caulk was used, one can check certain ends of caulk lines or cut into the caulk bead at a relatively concealed location and find the chromatic indicator at the center of the bead. Quality control assurances are maintained.

The wedge shape of chromatic indicator 2 seen in FIG. 2 may be varied without departing from this invention. Thus, a body of chromatic indicator 2 having a circular or rectangular cross section extending the entire length of the side wall 12 and adjacent the sidewall 12 will provide a bead B as seen in FIGS. 3 and 4. Moreover, a body of chromatic indicator 2 at the center of the principal materials will provide a concealed indicator with the stripe buried in the center of a caulk, sealant or adhesive bead.

Not all caulks are sold in packages having nozzles. Some caulks, sealants, and adhesives are sold in cylindrical packages called “sausages.” A sausage package is schematically shown in FIG. 7. A sausage package 40 is basically a cylindrical container comprised of a cylindrical side wall 42, a disk shaped front wall 44, a disk shaped rear wall 46 and a body of adhesive, caulk for sealant contained within. Sausage packages 40 come in different sizes with side walls and end walls fabricated from different materials such as plastic, paper and the like and with end walls having slightly different characteristics. The unifying characteristics of sausage packages is their generally cylindrical overall shape, their containing of a cylindrical body of material to be dispensed, and their ability to be loaded into a particular dispensing gun and dispensed through an opening which is cut or ripped into the disk front wall into a nozzle of the dispensing gun to form a bead. Dispensing from a sausage package 40 is similar to dispensing from the nozzle bearing package of sealant product 10 in that applying pressure at the rear end 46 causes the body of caulk to travel in a predictable manner forward to the opening in a front wall 44 and into the nozzle where the body of caulk is reduced in diameter but flows in a predictable manner maintaining its overall cross sectional disposition having a reduced circumference. The cross section of a body of adhesive, sealant or caulk as contained in a sausage package of FIG. 7 is shown in FIG. 8. The cross section is virtually identical to the cross section of the first embodiment seen in FIG. 2. Thus, a first or principal material 1 occupies the majority of the volume within the sausage package 40. A wedge shaped portion of a chromatic indicator or second material 2 occupies a volume of generally uniform cross sectional shape over the entire length of the sausage package 40. The entire body of material is surrounded by the cylindrical side wall 42.

When the material contained within the sausage package 40 is dispensed through a dispenser having a nozzle, the dispensing action and the bead created is identical to that seen in FIG. 3 or 5. That is, the material is dispensed in a manner which maintains its cohesiveness and the first material and second material remain distinct but of a single bead of caulk.

Any package used to contain and dispense caulk, sealant, or adhesive from a cylindrical storage base through a nozzle by means of applying pressure in a mechanism which will maintain the integrity and orientation of segregated but adjacent materials in the dispensing process are suitable for use in the present invention.

A single wedge or other cross section of chromatic indicator in a body of principal material is not the only orientation in which a chromatic indicator may be used. It must be remembered that one can use substantially similar materials as both the principal material and chromatic indicator. The principal material will have one coloring agent in it to provide a first color while the chromatic indicator will have a second coloring agent in it providing a second color. All other component parts of the sealant, caulk or adhesive may be the same and the physical attributes of the two materials will be indistinguishable. Thus, a significant portion of the volume of the material to be dispensed can be chromatic indicators. With reference to FIG. 9, one sees a cross section of a cylindrical container such as the package sealant product 10 of FIG. 1 or the sausage of FIG. 7. A first or principal material 1 again occupies most of the volume contained within the cylindrical side wall 12. A second material or first chromatic indicator 2 occupies a wedge along the length of the container. A third material or second chromatic indicator 3 occupies a similar wedge adjacent the first chromatic indicator 2. When this body of sealant is dispensed through a nozzle with the chromatic indicators 2, 3 in the uppermost position, a bead with two color stripes adjacent one another is dispensed as seen in FIG. 10. The bead B is comprised of a principal material 1, a first chromatic indicator stripe 2 and a second chromatic indicator stripe 3. The two stripes of chromatic indicators are parallel to one another down the center of the bead. A cross section of this bead is seen in FIG. 11 showing the bead B, the body of principal material 1 and the bodies of chromatic indicators 2 and 3 in the top center most visible portion of the bead. With this arrangement, more differentiations between types of caulk, grades of caulk and sealants can be made. For instance, one could choose a color for the first chromatic indicator indicating that the caulk is temperature resistant and a color for the second chromatic indicator 3 indicating the temperature range for which the caulk is matched. Alternatively, the first chromatic indicator 2 can be of a color indicating general purpose caulk and a second chromatic indicator 3 could indicate quality or expected lifetime of caulk.

The chromatic indicator does not need to be restricted to a wedge shape portion of the cross section of the body of caulk to be dispensed. As seen in FIG. 12, the caulk contained within the package sealant product 10 can be divided equally between a first material 1 and a second material 2 each occupying one half of the volume contained within the cylindrical side wall 12. The indicator mark 32 on the exterior of the package sealant product 10 can mark the center of one of the hemi cylinders or the dividing line 52 separating the two bodies of material. The bead laid down by a caulking gun filled with package sealant product 10 containing the materials as shown in FIG. 12 is shown in FIGS. 13 and 14. With the dividing line 52 orientated vertically, the bead B consists of a longitudinal half of the principal material 1 and a longitudinal half of the chromatic indicator 2 aligned next to each other forming a unified cohesive bead of caulk of two colors. Such an arrangement might be desirable to indicate a particular caulk, sealant or adhesive. Such an arrangement might be desirable for purely decorative purposes. Alternatively, the first material 1 can be selected for adhesion to a given substrate such as glass while the second material or chromatic indicator 2 is selected for good adhesion to a second material such as oily wood, for instance teak. The two materials adhere well to one another and particularly well to the substrates in mind. A worker desiring to caulk between two very different substrates requiring different caulks to gain appropriate adhesive orientates the caulking gun or dispensers to apply the caulk to the appropriate substrates thereby obtaining optimum adhesion to the two surfaces and an improved caulk. This is also appropriate for an adhesive. The chromatic differentiation between the two halves of the caulk bead aid in assuring that the appropriate caulk or adhesive half is applied to its intended substrate.

Still another embodiment of the invention is shown in FIG. 15. A cylindrical body of caulk comprised of a first or principal material 1, a first chromatic indicator 2 and a second chromatic indicator 3 is contained within the cylindrical side wall. The principal material occupies a volume having a cross sectional shape of a segment, that is an arc of a circle and its chord. The second chromatic indicator 3 occupies a mirror image segment opposite the first or principal material 1. The first chromatic indicator 2 occupies the elongate central stripe between the principal material 1 and the second chromatic indicator 3. When dispensed, if the first chromatic indicator is orientated vertically, a bead of caulk having a first color on the right side, a central portion of a second color and a third color on the left side is laid down. This combination can be desirable purely for indicator purposes. This combination can also be desirable to indicate two different caulk formulations for adhesion to different substrates on the right and left side with a grade indicator in the center. The color combination may be chosen strictly for its decorative purposes.

Another embodiment of the invention is illustrated in FIG. 16. FIG. 16 illustrates a cross section of caulk as contained within a cylindrical side wall 12. A principal material 1 occupies three symmetrically disposed large wedge portions of the cross section. The first chromatic indicator 2 material occupies three smaller wedges symmetrically disposed between the three larger wedges of the principal material 1. This orientation and division assures that no matter how the package sealant product 10 is orientated within a caulking gun, a dispensed bead of caulk will resemble the bead seen in FIG. 3 in that a stripe of the chromatic indicator material 2 will appear in the visible portion of the bead. Even if the caulking gun is orientated so that one or two of the indicator portions are buried in the bead of caulk even in the corner, the third strip of the chromatic indicator will be visible.

These orientations of first, second and third materials are not exhaustive. With reference to the arrangement of FIG. 16, the three large wedge shape principal material portions could rather be three wedge shapes of different colors. Moreover, the three smaller wedge shapes of chromatic indicator could all be different colors as well resulting in six different colors of caulk arranged for dispensing as a multi-colored stripe of caulk, sealant or adhesive in a bead. Any number of different colors can be arranged as adjacent stripes, or as space stripes in a base color. It must be remembered, that coloring of caulk sealants and adhesives can be performed without affecting its base performance characteristics because the level of filling needed to achieve a reasonable color presentation is small.

The chromatic indicator used in the present invention does not always need to be visible. One mechanism for hiding a chromatic indicator was described with respect to FIGS. 5 and 6. Another method is illustrated in FIGS. 17, 18 and 19. The embodiment of the invention seen in FIGS. 1, 2, 3 and 4 is used to lay down a bead of caulk bead comprised of a body of principal material 1 and a stripe of the chromatic indicator 2. However, the pigment used in the chromatic indicator is selected to fade when exposed to sunlight for a selected period of time. The chromatic indicator also carries pigments necessary to make the same color as the principal material 1. As the bead of caulk, adhesive or sealant is exposed to sunlight as in FIG. 18, the sunlight causes the distinctive pigment in the chromatic indicator 2 to fade. After a sufficient passage of time, the visual indication and distinctiveness of the chromatic indicator completely fades away at the surface leaving a bead of caulk of uniform exterior color as seen in FIG. 19. The distinctive pigment may be reactive to moisture or air to cause fading rather then light sensitive and achieve the same result. Thus, the chromatic indicator and performance function of indicating the appropriate caulk is in use during installation but then fade away leaving an aesthetically pleasing uniform bead of caulk matching the surrounding for the long term. The coloring agents can be selected so that the fading occurs only at the surface, leaving a body of colored chromatic indicator within the bead which can be exposed by cutting or scraping at a later time.

Still another mechanism for concealing the chromatic indicator of the present invention is illustrated in FIGS. 20, 21 and 22. A body of caulk including a wedge of chromatic indicators as seen in FIGS. 1, 2, 3 and 4 is laid down to form a bead B as seen in FIG. 20. However, the distinctive pigments in the chromatic indicator 2 are not visible in normal conditions and the bead B appears to be made up of entirely of the principal material 1. When the bead B is illuminated with light of a selected wave length L as illustrated in FIG. 21 the pigments in the chromatic indicator fluoresce and the chromatic indicator becomes visible having a color selected in the design process. One can thereby check to see that the appropriate caulk or adhesive has been used. When the light L of a selected wave length is removed, the fluorescent pigments in the chromatic indicator become quiescent and the bead B appears to be composed entirely of caulk, adhesive or sealant of the principal material 1 as shown in FIG. 22.

Another embodiment of the invention is illustrated in FIG. 23. FIG. 23 illustrates a cross section of caulk as contained within a cylindrical side wall 12. A principal material 1 occupies two oppositely disposed wedge portions of the cross section. The first chromatic indicator 2 material occupies two wedge portions oppositely disposed between the two wedges of the principal material 1. In this embodiment, the four wedge portions are approximately identical in size. However, the indicator wedge portions 2, could be made smaller and the principal material portions larger, if desired. This orientation and division assures that no matter how the package sealant product 10 is orientated within a caulking gun, a dispensed bead of caulk will display two colors in that a stripe of the chromatic indicator material 2 will appear in the visible portion of the bead. Even if the caulking gun is orientated so that one of the two indicator portions are buried in the bead of caulk even in the corner, the other strip of the chromatic indicator will be visible.

As shown in the accompanying drawings which constitute a part of the disclosure of the present application, the product in a dispensed form has a single bead B which includes a first material 1, such as the described principal material, and a second material 2, such as the described chromatic indicator material, the two materials being of distinct colors and separated along a length of the bead B. In some cases, the distribution of the materials 1 and 2 of the bead B may be substantially uniform. In other forms, the visible area of one or the other of the materials 1, 2 may be substantially less or greater than the other. For example, the chromatic indicator material may be in the form of a relatively thin line of material which is integral with the bead of material which includes the principal material.

The distribution pattern of the materials 1, 2 of the bead B is dictated primarily by the filling arrangement of the materials 1, 2 in a cartridge or tube, as known in the filling equipment art, wherein the quantities and relative locations of multiple low viscosity materials within a single undivided container can be designed and controlled. When the so-combined flowable material is dispensed or extruded from the cartridge, the two or more visually distinct materials remain in the same relative arrangement, such as side-by-side in a linear bead.

In a generally cylindrical cartridge, two materials or more may be filled in an arrangement wherein the materials occupy respective radial sectors, such as halves or quarters or smaller sector divisions of the cylindrical cross-section of a tubular cartridge, or other arrangements such as a thin line of chromatic indicator material within the principal material, or multiple thin lines of each material, or any other combinations.

The invention thus provides a novel building material combination which when dispensed or extruded has a unique multi-chromatic appearance with clearly visible segregation of the colors in a single homogeneous bead of the combined material.

The invention has been described with reference to several preferred embodiments. It will be appreciated that modifications or alterations can be made without deviation from the present invention. Such modifications and alterations will occur to others upon the reading and understanding of this specification. It is intended that all such modifications and alterations be included insofar as they come within the scope with the appended claims or the equivalents thereof. Having thus described the invention, it is claimed:

1. A sealant or adhesive product adapted to be dispensed from a tube through a nozzle into a bead, said sealant product contained in said tube as at least two components, said components comprising a principal material and at least one chromatic indicator material differing in color from said principal material in at least one selected condition, said principal material and said at least one chromatic indicator material positioned within said tube so as to exit said nozzle with said at least one chromatic indicator forming a longitudinal stripe in a dispensed bead.

2. The sealant or adhesive product of claim 1 wherein said at least one chromatic indicator material is in a constant radial position with respect to said nozzle whereby said stripe may be concealed within said bead or exposed to view.

3. The sealant or adhesive product of claim 1 wherein said chromatic indicator material is light sensitive and loses chromatic distinctiveness when exposed to light for a selected period of time.

4. The sealant or adhesive product of claim 1 wherein chromatic component is sensitive to a selected frequency of radiation and fluoresces when exposed to said selected frequency of radiation.

5. The sealant or adhesive product of claim 1 wherein said at least two components are contained in said tube as; at least one shaped body of a chromatic indicator material of substantially uniform shape and size over substantially the entire length of said tube; and, a body of principal material occupying the remaining volume within said tube.

6. The sealant or adhesive product of claim 5 wherein said at least one shaped body of chromatic indicator material abuts against said tube.

7. The sealant or adhesive product of claim 6 wherein said at least one shaped body of chromatic indicator material is wedge shaped.

8. The sealant or adhesive product of claim 5 wherein said at least one shaped body of a chromatic indicator material comprises at least two shaped bodies of chromatic indicator material of different colors.

9. The sealant or adhesive product of claim 8 wherein said at least two shaped bodies of chromatic indicator material are adjacent one another.

10. The sealant or adhesive product of claim 8 wherein said at least two shaped bodies of chromatic indicator material are spaced from one another.

11. The sealant or adhesive product of claim 1 wherein said principal material and said chromatic indicator material are contained in said tube in direct contact with one another.

12. The sealant or adhesive product of claim 1 wherein said chromatic indicator material is reactive to moisture and loses chromatic distinctiveness when exposed to moisture for a selected period of time.

13. The sealant or adhesive product of claim 1 wherein said chromatic indicator material is reactive to air and loses chromatic distinctiveness when exposed to air for a selected period of time.

14. A method of quality control in a process using at least one caulk, sealant or adhesive comprising;
providing a caulk, sealant or adhesive in a tubular container, said caulk, sealant or adhesive comprising a principal material and at least one chromatic indicator material, said at least one chromatic indicator material having a visually discernable characteristic indicative of a property of said caulk, sealant or adhesive;
applying said caulk, sealant or adhesive to a substrate or substrates;
examining said applied caulk, sealant or adhesive; and
determining that said at least one chromatic indicator material indicates an appropriate property of caulk, sealant or adhesive.

15. The method of claim 12 wherein said at least one chromatic indicator material forms at least one stripe in said applied caulk, sealant or adhesive.

16. The method of claim 13 wherein said at least one stripe is buried in said applied caulk, sealant or adhesive and said examination of said applied caulk, sealant or adhesive comprises the examination of an end or cross section of said applied caulk, sealant or adhesive.
